(19) United States
(12) Patent Application Publication
(10) Pub. No.: US 2006/0054681 A1
(43) Pub. Date: Mar. 16, 2006

(54) Electronic appliance having readable/writable radio frequency identification tag and method of assembling the same

(75) Inventors: Sang-Cheol Park, Suwon-si (KR); Young-Min Kim, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/212,647

(22) Filed: Aug. 29, 2005

(30) Foreign Application Priority Data
Sep. 7, 2004 (KR) 2004-71052

(51) Int. Cl. G06F 17/00; G06K 13/063; G08B 13/14

(52) U.S. Cl. 235/375; 235/485; 340/572.8

(57) ABSTRACT

An appliance is provided having a body frame which receives and supports various components or units of the appliance. At least one RFID tag is attached to a side of the body frame. Various product-related information can be read from or written into the RFID tag through RF communication. The RFID tag is arranged in a position accessible from the outside of the body frame by using an RFID reader/writer.

### CROSS-REFERENCE TO RELATED APPLICATIONS

This application claims the benefit under 35 U.S.C. § 119(a) of Korean Patent Application No. 2004-71052, filed Sep. 7, 2004, the entire disclosure of which is hereby incorporated by reference.

### BACKGROUND OF THE INVENTION

1. Field of the Invention

The present invention relates to an electronic appliance such as a printer, a copying machine, or a facsimile which utilizes a radio frequency identification (RFID) tag. More particularly, the present invention relates to an electronic appliance configured to have product-related information which can read from or written into the RFID tag through radio communication and a method of assembling the same.

2. Description of the Related Art

RFID is an automatic identification technology employing radio frequency (RF) identification which utilizes contactless cards. In the future, RFID technology will most likely replace conventional bar codes and magnetic cards.

Conventional RFID systems comprise a reader, a host computer and a tag called a transponder. The card activates and transmits the ID and data to the antenna upon entry into a magnetic field. The antenna converts the ID received from the card into a data signal and transmits the data signal to a computer. The computer compares the data signal with data base previously stored therein and provides a desired service.

RFID tags are rapidly spreading due to advantages over existing bar code and self-recognition devices, convenience, change in production methods thereof, changes in consumer consciousness, and cultural and technological progress and development.

In the past, a low frequency band (125 KHz-400 KHz) a typically employed in short-range transmissions for an RFID application field. However, a typical carrier frequency (reader's transmitting frequency) range is 125 KHz to 2.4 GHz. Recently, the high frequency (4 MHz-20 MHz) and microwave (2.45 GHz) application area has also been extended and a frequency band of 13.56 MHz is on the way to being standard.

RFID systems are being employed in developing cartridges for image forming apparatuses such as printers, copying machines, and facsimile devices. Here, information stored in a storage member of an RFID tag mainly contains information related to life expectancy, the quantity of toner of a developing unit including the quantity of toner used by the developing unit, and the amount of paper.

Because information in the developing cartridge can be transmitted through radio communication, as described above, it is not necessary to provide a contact terminal or the like between a developing cartridge and a printer body. Therefore, a construction of the system may be simplified.

Most electronic appliances including printers or copying machines as described above are shipped in a packaged state. Information related to such electronic appliances, such as, model name, production date, production factory information, and manufacturer information are arranged on the bodies of the electronic appliances. Labels for identifying product-related information are attached to packages enclosing the electronic appliances for managing distribution or the like because the product-related information provided on the bodies is not visible due to packaging.

In addition, in order to manage products in the process of distribution, it is necessary to directly and visually confirm labels attached to the products for identifying the product-related information. Therefore, it is inconvenient to manage distribution of such products.

Furthermore, ordinary electronic appliances have a disadvantage in that it is difficult to ascertain repair service history thereof because no record related to after-sales servicing remains even if after-sale servicing were performed.

Accordingly, there is a need for an improved electronic appliance and method of assembling the same, where product-related information can be relatively easily written and used.

### SUMMARY OF THE INVENTION

An exemplary embodiment of the present invention is to address at least the above problems and/or disadvantages and to provide at least the advantages described below. Accordingly, an aspect of the present invention is to provide an electronic appliance having a readable and writable RFID tag for storing product-related information. According to an exemplary implementation, the RFID tag is externally accessible so that it is not necessary to attach a separate label having product-related information, whereby, management and distribution of the product can be facilitated.

Another exemplary object of the present invention is to provide an electronic appliance having an RFID tag, wherein new information, such as, after-sales servicing items and preventative maintenance details can be recorded in the RFID tag, thereby facilitating management of service of the product after distribution.

Still another exemplary object of the present invention is to provide a method of assembling an electronic appliance having a readable/writable tag as described above.

In order to achieve the above-mentioned exemplary objects, there is provided an electronic appliance comprising a body frame which receives and supports, for example, various components or units of the electronic appliance, and at least one RFID tag attached to a side of the body frame. Various product related information may be read from or written into the RFID tag through RF communication.

According to an exemplary embodiment, the RFID tag is arranged in a position accessible from the outside of the body frame. For example, the RFID tag can be arranged in a position so that the information can be read from or written into the RFID tag, by using an RFID reader/writer, from the outside of the package after the product has been packaged.

In addition, a marking to indicate the position of the RFID tag can be provided, for example, on the packaging of the product.

According to an exemplary embodiment, the product-related information may be the information related to model name, production date, production factory information, manufacturer information, and after-sale servicing history, and the information can be either recorded at the time of assembling the product or changed in the packaged state when any of the information items is changed.

According to another exemplary aspect of the present invention, there is provided a method of assembling an electronic appliance having an RFID tag comprising the steps of assembling various components and units of the electronic appliance on a body frame of the appliance, and arranging an RFID tag on the body frame. Product-related information can be read from or written into the RFID tag. According to an exemplary aspect of the present invention, function of the assembled product is tested, the external appearance is inspected, product-related information is input into the RFID tag using an RFID reader/writer, and the product is packaged.

According to an exemplary embodiment, a marking on the packaging to indicate the position of the RFID tag within the packaging can be provided during for example the step of packaging the product.

Still, according to another exemplary aspect of the present invention, there is also provided an image forming apparatus comprises an image forming unit including a photoconductive medium, an image transfer unit which transfers an image formed on the image forming unit to a printing medium, a fixation unit which fuses the image to the printing medium via heating and pressure, a body frame which receives and supports the above mentioned components, and at least one RFID tag arranged on a side of the body frame, wherein various product-related information can be read from or written into the RFID tag through RF communication.

According to an exemplary implementation the RFID tag is arranged in a position accessible from the outside of the body frame.

According to an exemplary implementation a marking to indicate the position of the RFID tag is provided on a package to enclose and maintain the image forming apparatus substantially in position.

The product-related information may be the information related to model name, production date, production factory information, manufacturer information, and or after-sale servicing history of the image forming apparatus.

A exemplary method of assembling such an image forming apparatus having an RFID tag as described above comprises the steps of assembling various components and units of the image forming apparatus including an image forming unit, an image transfer unit and a fixation unit to the body frame, attaching an RFID tag to a body frame, wherein product-related information can be read from or written into the RFID tag, testing the function of the assembled product, inspecting the external appearance of the product, inputting product-related information into the RFID tag using, for example, an RFID reader/writer, and packing the product.

### BRIEF DESCRIPTION OF THE DRAWINGS

The above and other objects, features, and advantages of certain exemplary embodiments of the present invention will be more apparent from the following description taken in conjunction with the accompanying drawings, in which:

FIG. 1 is a schematic view showing an image forming apparatus, which is an example of an electronic appliance with a readable/writable RFID tag according to an embodiment of the present invention, in a packaged state;

FIG. 2 is a schematic view showing an image forming apparatus, which is an example of an electronic appliance with a readable/writable RFID tag according to another exemplary embodiment of the present invention; and

FIG. 3 shows an example of a process of assembling an electronic appliance in accordance with the exemplary embodiments of the present invention.

Throughout the drawings, the same drawing reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of exemplary embodiments of the invention. Accordingly, those of ordinary skill in the art will recognize that various changes and modifications of the exemplary embodiments described herein can be made without departing from the scope and spirit of the invention. Also, descriptions of well-known functions and constructions are omitted for conciseness.

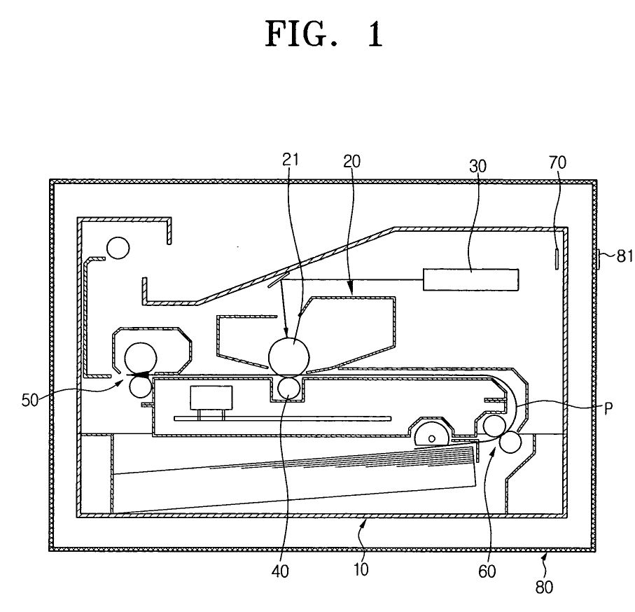

FIG. 1 schematically shows an image forming apparatus as an example of an electronic appliance with an RFID tag according to an exemplary embodiment of the present invention in a packaged state. Although an image forming appliance is described by way of an example for the convenience of description in the following, the term, “electronic appliance” may include any electric or electronic appliance as well as an image forming apparatus.

In FIG. 1, a body frame 10 forms an external enclosure of an image forming apparatus. A, n exposure unit 20, a laser scanning unit 30, an image transfer unit 40, a fixation unit 50, a paper-feeding unit 60, an RFID tag 70, and a product package 80 with a marking 81 are provided.

The image forming unit 20 includes a photoconductive medium 21. Although not shown in detail in the drawing, the image forming unit 20 also includes a developing section. As the laser scanning unit 30 scans a laser beam, a desired electrostatic latent image is formed on the photoconductive medium 21 and the electrostatic image is developed into a visible image with toner through the developing section. The visible image is transferred to a printing medium, such as paper, fed from the paper-feeding unit 60 by the image transfer unit 40. Then, the image transferred to the printing medium is fused via application of heat and pressure while passing through the fixation unit 50. Lastly, the paper is discharged.

RFID tag 70, according to an exemplary aspect of the present invention, is a memory means which allows product-related information, such as, model name, production date, production factory information, manufacturer information, after-sales servicing history, or the like to be recorded into or read from the RFID tag 70. According to an exemplary implementation, the RFID tag 70 is attached to a side of an inner wall of the body frame 10 as shown in FIG. 1.

In an exemplary implementation, the RFID tag 70 is arranged in a position accessible from the outside of the body frame 10, for example, a position proximal to the outside of a package 80 within the body frame 10 so as to facilitate reading stored information from or writing new information into the RFID tag using an RFID reader or writer from the outside of the package 80 after the product has been packaged.

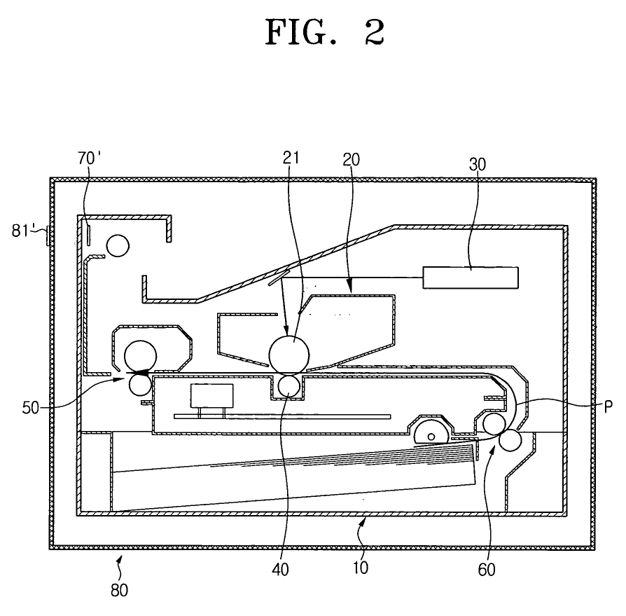

As shown in FIG. 1, the RFID tag 70 is arranged on an area of the inner wall of the body frame 10 where the exposure unit 30 is installed. This location is may be preferable in practical image forming apparatuses because interference with other, components is reduced and the location is proximal to the outside of the package 80. However, the RFID tag 70 may be attached to any position readily accessible from the outside, including, for example, a place on the inner wall adjacent to the paper-discharge part, as shown in FIG. 2. Additionally, if desired and suitable, more than one RFID tag 70 may be used.

RFID tags 70 or 70′ may be classified as active tags or passive tags depending on whether the RFIG tag 70 or 70′ houses a battery. An active tag houses a battery and transmits a signal, for example, according to a predetermined time interval while the battery is in service. Although active tags are capable of remotely-transceiving a signal, they have limited use because of cost and restricted terms for use. In the exemplary embodiment, a passive tag is used. The passive tag is not provided with a battery. Passive tags comprise an antenna coil and a chip. If the tag enters an area of magnetic field radiated from a reader, AC voltage is applied to the antenna coil of the tag and the antenna coil rectifies the voltage into a DC voltage, which will be used as power required for the chip. When a predetermined level of voltage is applied to the chip, the chip activates and transmits data to the reader. The tag reading range is typically determined by the circuit and size of the antenna. Tags having a relatively short tag reading range of about 2 cm to 70 cm can be widely employed in material flow, manufacturing, traffic, and domestic animal managing fields.

An RFID reader serves to supply RF energy to a passive tag, thereby activating the passive tag and receiving information from the tag. For this purpose, the reader includes an assembly for sending and receiving signals and decoding data. Additionally, the reader performs communications such as, for example, series communication (RS-232), USB, or Ethernet or the like with a host computer. The RF transmitting assembly comprises an antenna circuit, an antenna tuning circuit and an RF carrier generator. The RF transmitting assembly can be designed, for example, to be properly tuned so as to exhibit the relatively best function of the antenna tuning circuit and the antenna. It is possible to obtain data by decoding a received signal through a microcontroller, wherein a firmware algorithm within the microcontroller sends an RF signal, interprets a received signal, and communicates with a host computer. According to an exemplary implementation, a reader has a reading function only. A device having both reading and writing functions is called an interrogator. An interrogator performs, for example, reading and writing functions unlike a reader only performing reading function. The interrogator uses pulses containing a command when communicating with a tag for the purpose of those functions.

An antenna, for example, is a device employed for reading data from or writing a data into a tag or card using an RF frequency. According to exemplary implementations, some systems separately use an antenna and a controller, while some systems comprise an antenna and a controller, which are built in an antenna or a reader/writer.

According to another aspect of the present invention, a package 80 for packaging a product (for example, an assembled image forming apparatus) is marked with marking 81 or 81′ for indicating the position where the RFID tag 70 or 70′ of the packaged product is attached, as shown in FIGS. 1 and 2. Therefore, distribution personnel can recognize the position of the RFID tag and confirm product information.

Assembling an electronic appliance product, such as, for example, an image forming apparatus, having an RFID as described above, comprises, for example, the steps of providing a readable/writable tag and inputting product-related information, such as, for example, model name, production date, production factory information, manufacturer information, after-sales servicing history, or the like into the tag before finally packaging the product.

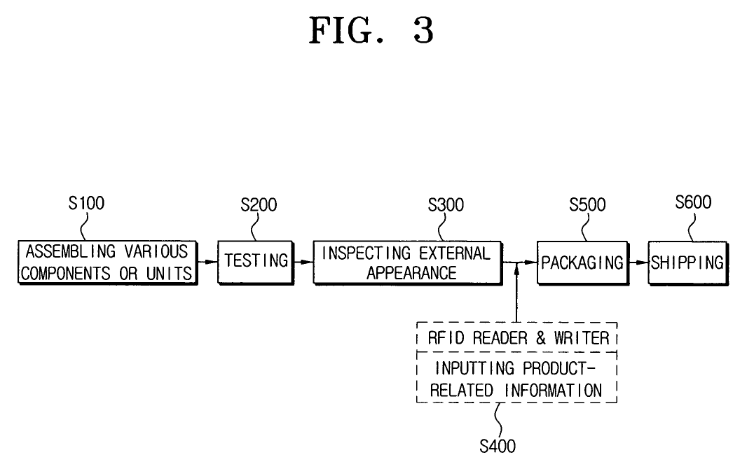

For example, as shown in FIG. 3, the exemplary method of assembling an image forming apparatus comprises the steps of assembling various components including the image forming unit, the image transfer unit and the fixation unit on the body frame (S100), arranging an above-mentioned readable/writable RFID tag in an appropriate position on the body frame, testing the function of the product (for example, an image forming apparatus) assembled as described above (S200), inspecting the external appearance of the product (S300), and inputting product-related information into the RFID tag using an RFID reader/writer before the step of packaging the product (S500). Thereafter, the product is packaged and shipped (S600).

According to an exemplary implementation of an RFID tag, space is provided for storing the after-sales servicing history such as reoccurring problems with a particular item and servicing details, after the product is sold to a consumer. This information to can facilitate management of service of the product after sale.

According to an exemplary aspect of the present invention, In addition, it is possible to efficiently manage distribution from a viewpoint of material flow, because the product-related information in the product in the packaged state can be readily and correctly confirmed. According to an exemplary aspect of the present invention, it is possible to record new product-related information in the packaged state, for example, when the product-related information has been changed.

As described above, the exemplary embodiments of the present invention facilitate confirmation and management of a product in the process of distribution, thus, making it possible to rapidly process material flow because detailed information for a product within a package can be confirmed in the packaged state. According to an exemplary aspect of the present invention, information in an RFID tag attached to the product within the package can be changed as is desired.

According to an exemplary aspect of the present invention, because it is not necessary to attach a label for identifying product-related information to a package, it is possible to save costs and facilitate assembly of the product.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. An appliance, comprising:
a body frame comprising at least one component in an interior of the body frame; and
at least one RFID tag attached to a side of the body frame, wherein product-related information is readable from or writeable into the RFID tag via RF communication.

2. An appliance as claimed in claim 1, wherein the RFID tag is arranged in a position accessible from an exterior of the body frame.

3. An appliance as claimed in claim 2, further comprising a package which encloses at least the body frame, the package comprising a marking indicative of the position of the RFID tag on an exterior of the package.

4. An appliance as claimed in claim 1, wherein the product-related information comprises at least one of model name, a production date, production factory information, manufacturer information, and after-sale servicing history.

5. The appliance as claimed in claim 1, further comprising:
an image forming unit which forms an image comprising an image transfer unit which transfers the image formed on the image to a printing medium; a fixation unit which fuses the image to the printing medium via heat and pressure;
wherein the body frame comprises the image forming unit, the image transfer unit, and the fixation unit in the interior of the body frame.

6. The appliance as claimed in claim 5, wherein the RFID tag is arranged in a position accessible from an exterior of the body frame.

7. The appliance as claimed in claim 6, further comprising a package to encloses at least the body frame, the package comprising a marking indicative of the position of the RFID tag.

8. The appliance as claimed in claim 7, wherein the product-related information comprises at least one of model name, a production date, production factory information, manufacturer information, and after sale servicing history.

9. The appliance as claimed in claim 1, wherein the RFID tag is attached to a side of the body frame.

10. The appliance as claimed in claim 3, wherein the RFID tag is arranged on an exterior of the package.

11. The appliance as claimed in claim 1, wherein the appliance is an electrical appliance.

12. A method of assembling an appliance comprising an RFID tag, the method comprising the steps of:
providing at least one component in a body frame,
arranging an RFID tag on the body frame,
wherein product-related information is readable from or writeable into the RFID tag;
inputting the product-related information into the RFID tag; and
packaging the product in a package.

13. A method as claimed in claim 12 further comprising step of:
providing a marking on the packaging indicative of a position of the RFID tag during the step of packaging the product.

14. A method as claimed in claim 13 wherein the marking is provided during the step of packaging the product.

15. A method as claimed in claim 12, wherein the product-related information comprises the inputting of at least one of a model name, a production date, production factory information, manufacturer information, and after-sale servicing history.

16. The method as claimed in claim 12 wherein the step of providing comprises the steps of:
providing an image forming unit;
providing an image transfer unit; and
providing a fixation unit.

17. The method as claimed in claim 16 wherein the image forming unit includes a photoconductive medium.

18. The method as claimed in claim 16 wherein the fixation unit fuses the image to the printing medium via heat and pressure.

19. A method as claimed in claim 12 further comprising step of:
providing a marking on the packaging indicative of a position of the RFID tag during the step of packaging the product.

20. A method as claimed in claim 12, wherein the product-related information comprises at least one model name, a production date, production factory information, manufacturer information, and after sale servicing history.

21. A method as claimed in claim 12, wherein the step of providing includes the steps of:
testing the function of the assembled product; and
inspecting the external appearance of the product;
wherein the inputting step includes the inputting of the product-related information into the RFID tag using an RFID reader/writer.
